(19) United States
(12) Patent Application Publication
(10) Pub. No.: US 2016/0185296 A1
(43) Pub. Date: Jun. 30, 2016

(54) VEHICLE BLACK BOX MOUNTABLE ON REAR-VIEW MIRROR SUPPORT

(71) Applicant: TEKFORUS INC., Seoul (KR)

(72) Inventor: Jae Woug LEE, Seoul (KR)

(73) Assignee: TEKFORUS INC., Seoul (KR)

(21) Appl. No.: 14/585,743

(22) Filed: Dec. 30, 2014

(51) Int. Cl. B60R 1/04; B60R 11/04

(52) U.S. Cl. CPC B60R 1/04; B60R 11/04; B60R 2011/0033

(57) ABSTRACT

A vehicle black box mountable on a rear-view mirror support is disclosed herein. The vehicle black box includes an imaging module including a lens for capturing images and a circuit for driving the lens, and a black box body containing the overall imaging module or part of the imaging module including the lens. The black box body is fastened to a fastening part forming a rear-view mirror support within a vehicle, while covering the fastening part.

### BACKGROUND

1. Technical Field

The present invention relates to a vehicle black box mountable on the windshield glass portion of a vehicle and, more particularly, to a vehicle black box mountable on a rear-view mirror support.

2. Description of the Related Art

In general, a black box includes an image sensor, a positioning sensor, an impact sensor, and a micro sensor, and records changes in an environment that occur while a vehicle is running or being stopped. Conventionally, a black box is mounted on an airplane, and is used to determine the cause of an airplane accident when the airplane accident occurs. Recently, a black box is mounted on a vehicle or other transportation means, and is used to record information about the driving manipulation of a driver and surrounding information regarding a specific event.

In general, a black box is installed near a rear-view mirror or over a dashboard within a vehicle. A black box is chiefly used to capture images in front of a vehicle, record the captured images in a moving image form, and determine the cause of a traffic accident when the traffic accident occurs.

If a conventional black box is installed near a rear-view mirror, it is fastened to a windshield glass or the inside of the vehicle. If the black box is fastened to the windshield glass of a vehicle, it is fastened using a double-sided adhesive tape. In this case, there is a possibility that the double-sided adhesive tape is detached from the windshield glass when it is used for a long time or in hot summer. Furthermore, problems arise in that, since the black box is installed separately from the rear-view mirror, the windshield glass portion of the vehicle becomes complicated, the visual field of a driver is obstructed, and an appearance becomes poor.

### SUMMARY

Accordingly, the present invention has been made keeping in mind the above problems occurring in the prior art, and an object of the present invention is to provide a vehicle black box mountable on a rear-view mirror support, which does have a possibility that the vehicle black box is separated because of its secure fastened state unless it is intentionally separated by a user, does not have a possibility that the visual field of a driver is obstructed, and provides an aesthetic appearance.

In accordance with an aspect of the present invention, there is provided a vehicle black box mountable on a rear-view mirror support, the vehicle black box including an imaging module including a lens for capturing images and a circuit for driving the lens; and a black box body containing the overall imaging module or part of the imaging module including the lens; wherein the black box body is fastened to a fastening part forming a rear-view mirror support within a vehicle, while covering the fastening part.

The black box body may include a clamping part detachably fastened to the fastening part using a fastening member while covering the fastening part; and a housing detachably combined with the clamping part and containing all or part of the imaging module.

The clamping part may include a support cover member having a recess so that it covers the fastening part, the support cover member having a screw hole through which a screw passes.

The screw may sequentially pass through the black box body and the screw hole so that the black box body is fastened to the clamping part and hung onto a head part of the screw.

The clamping part and the housing may be fastened to each other by a hooking means.

The black box body may consist of two parts which may be divided longitudinally or laterally, the two parts may be detachably combined with each other while covering the fastening part.

The black box body may include a lens through hole through which the lens of the imaging module is exposed; vent holes to dissipate heat generated on operating the imaging module; an indicator to indicate that the imaging module is under operation; a card socket into which a memory card is inserted; a power switch to turn on or off power; and an operation switch to control operation of the imaging module.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a state in which a vehicle black box mountable on a rear-view mirror support according to a first embodiment of the present invention has been installed;

FIG. 2 is an exploded perspective view of the vehicle black box mountable on a rear-view mirror support according to the first embodiment of the present invention;

FIG. 3 is a perspective view illustrating the assembled state of the vehicle black box illustrated in FIG. 2;

FIG. 4 is a perspective view of FIG. 3 viewed from below;

FIG. 5 is a cross-sectional view illustrating a state in which the vehicle black box has been installed on the rear-view mirror support of FIG. 2;

FIG. 6 is a diagram illustrating a state in which a vehicle black box mountable on a rear-view mirror support according to a second embodiment of the present invention has been installed;

FIG. 7 is an exploded perspective view of the vehicle black box mountable on a rear-view mirror support according to the second embodiment of the present invention;

FIG. 8 is a perspective view illustrating the assembled state of the vehicle black box illustrated in FIG. 7;

FIG. 9 is a perspective view of FIG. 8 viewed from below;

FIG. 10 is a cross-sectional view illustrating a state in which the vehicle black box has been installed on the rear-view mirror support of FIG. 7;

FIG. 11 is a diagram illustrating a state in which a vehicle black box mountable on a rear-view mirror support according to a third embodiment of the present invention has been installed within a vehicle;

FIG. 12 is an exploded perspective view illustrating a state in which the vehicle black box has been separated from the rear-view mirror support in FIG. 11;

FIG. 13 is a front view of a first housing illustrated in FIG. 12;

FIG. 14 is a side view of the first housing illustrated in FIG. 12;

FIG. 15 is a plan view illustrating a state in which an imaging module has been mounted in the first housing in the vehicle black box mountable on a rear-view mirror support according to the third embodiment of the present invention;

FIG. 16 is a perspective view of a vehicle black box mountable on a rear-view mirror support according to a fourth embodiment of the present invention;

FIG. 17 is a front view of FIG. 16;

FIG. 18 is a side view of FIG. 16;

FIG. 19 is a rear view of FIG. 16;

FIG. 20 is a side view of a vehicle black box mountable on a rear-view mirror support according to a fifth embodiment of the present invention; and

FIG. 21 is a rear view of FIG. 20.

### DETAILED DESCRIPTION

Embodiments of a vehicle black box mountable on a rear-view mirror support will be described in detail below with reference to the accompanying drawings.

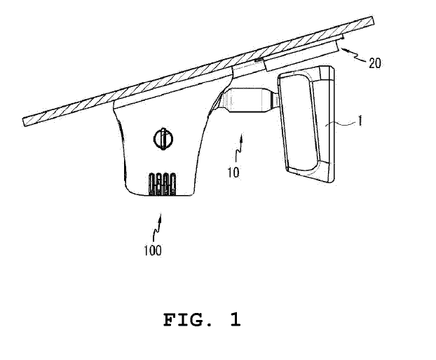

FIG. 1 is a diagram illustrating a state in which a vehicle black box mountable on a rear-view mirror support according to a first embodiment of the present invention has been installed.

A rear-view mirror 1 is securely fastened to the windshield glass portion of a vehicle using a rear-view mirror support 10. The vehicle black box 100 according to the present embodiment is not installed on windshield glass 2 separately from the rear-view mirror 1 unlike the conventional vehicle black box, but is mounted on the rear-view mirror support 10, not the windshield glass. The vehicle black box 100 is detachably mounted on the rear-view mirror support 10 using a fastening member while covering the rear-view mirror support 10.

The vehicle black box 100 according to the present embodiment has the advantage of a wide range of use because the vehicle black box 100 can be easily mounted on and separated from an existing rear-view mirror support as well as a newly installed rear-view mirror support, as will be described later.

Meanwhile, a signal line and a power line connected to the vehicle black box 100 are inserted into and arranged in a line guide 20 mounted on the ceiling of a vehicle.

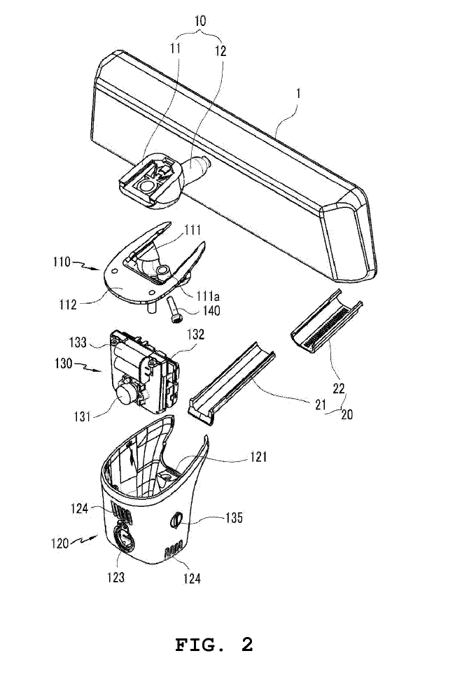

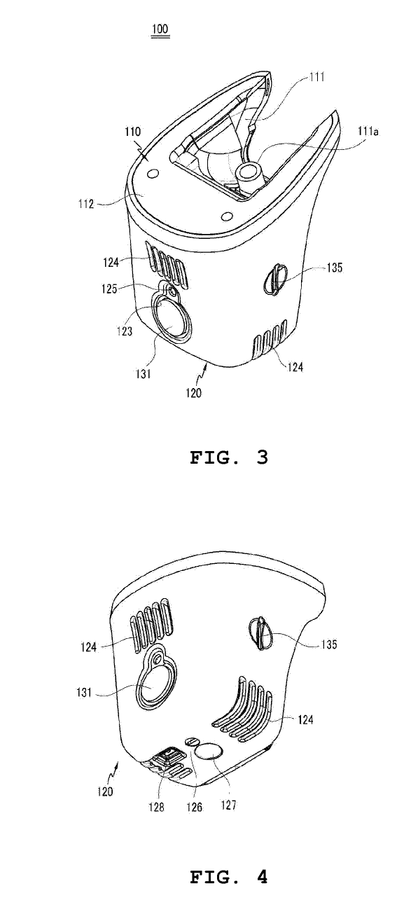

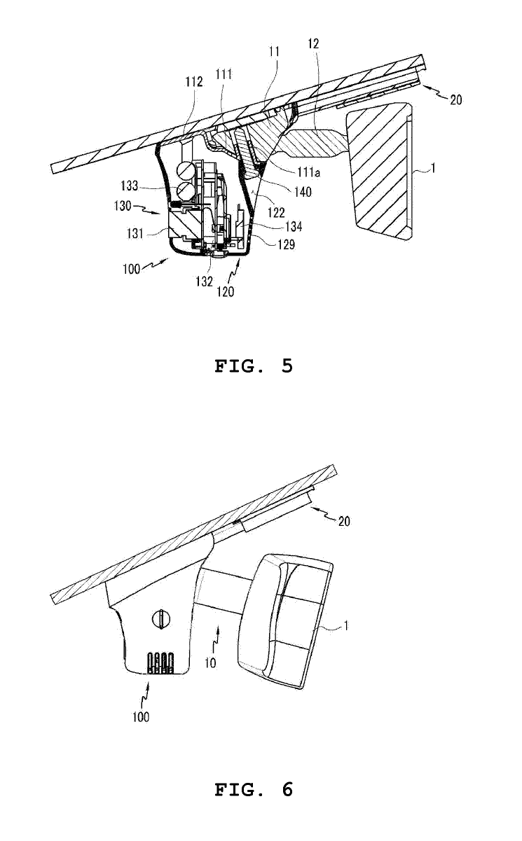

FIG. 2 is an exploded perspective view of the vehicle black box mountable on the rear-view mirror support according to the first embodiment of the present invention, FIG. 3 is a perspective view illustrating the assembled state of the vehicle black box illustrated in FIG. 2, FIG. 4 is a perspective view of FIG. 3 viewed from below, and FIG. 5 is a cross-sectional view illustrating a state in which the vehicle black box has been installed on the rear-view mirror support of FIG. 2.

The rear-view mirror support 10 includes a fastening part 11 fixedly attached to the windshield glass of a vehicle, and a rear-view mirror support part 12 rotatably combined with the fastening part 11 and to support the rear-view mirror 1. The fastening part 11 is fastened to the windshield glass by an adhesion means. The rear-view mirror support part 12 is configured such that the installation angle of the rear-view mirror 1 is freely controlled. The fastening part 11 may be fastened to other portions within the vehicle in addition to the windshield glass of a vehicle.

The vehicle black box 100 according to the present embodiment includes a clamping part 110 detachably combined with the rear-view mirror support 10 while covering the rear-view mirror support 10, a housing 120 detachably combined with the clamping part 110, and an imaging module 130 contained in the housing 120. In the present embodiment, the clamping part 110 and the housing 120 form a black box body.

A support cover member 111 is formed on the clamping part 110. The support cover member 111 has a cavity therein so that it can cover the fastening part 11 of the rear-view mirror support 10. A glass contact member 112 that comes into contact with the windshield glass of the vehicle extends to the front and both sides of the support cover member 111. The clamping part 110 also functions to cover the open top of the housing 120.

A hollow screw hole 111a through which a screw 140 passes is formed in the support cover member 111 so that the support cover member 111 and the housing 120 can be fastened to the fastening part 11 of the rear-view mirror support 10 using the screw 140. The upper portion of the screw hole 111a extends into the inside of the support cover member 111. Upon assembly, the screw hole 111a is inserted into a blind- or through-hole shaped screw fastening portion 11a that is formed in the fastening part 11 of the rear-view mirror support 10. That is, the screw fastening portion 11a may be formed in a blind-hole shape such that the screw 140 is engaged with a blocked portion in a threaded manner. Alternatively, the screw fastening portion 11a may be formed in a through-hole shape and be inserted into and fastened to a separate member in order to fasten the screw 140.

The glass contact member 112 may be attached to the windshield glass of a vehicle by an adhesion means, or may be simply brought into contact with the windshield glass of the vehicle. The glass contact member 112 may be inclined in accordance with the inclined surface of the windshield glass.

The imaging module 130 is detachably contained in the housing 120. The housing 120 has a cavity therein. The open top of the housing 120 is detachably combined with the clamping part 110 by a hooking means or a screw means. In some embodiments, the housing 120 and the clamping part 110 may be fastened to each other supplementarily using a screw in addition to using a hooking means.

A support part reception portion 121 into and through which the rear-view mirror support part 12 of the rear-view mirror support 10 is inserted and passes is formed at the upper end of the rear side of the housing 120. A screw catch depression 122 is formed below the support part reception portion 121 so that the screw part of the screw 140 passes through the screw catch depression 122 and the head part of the screw 140 is caught by the screw catch depression 122. The screw part of the screw 140 that passes through the screw catch depression 122 passes through the screw hole 111a of the support cover member 111. When the vehicle black box 100 is mounted, one end of the line guide 20 is inserted into the support part reception portion 121 and then connected to the vehicle black box 100. The line guide 20 is configured to include a plurality of telescopically arranged guide members 21 and 22 so that the length of the guide can be adjusted.

The imaging module 130 functions to capture images in front of the vehicle, and includes a lens 131, a circuit unit 132, a battery 133, a speaker 134 and a card socket 135. The lens 131 may be fastened to the circuit unit 132, or may be separate from the circuit unit 132. If the lens 131 and the circuit unit 132 are separate from each other, only the lens 131 may be contained in the housing 120 and the circuit unit 132 may be installed at a separate location within the vehicle. That is, the overall imaging module 130 or part of the imaging module 130 including the lens 131 may be contained in the housing 120. The speaker 134 and the card socket 135 are mounted in the housing 120 and electrically connected to the circuit unit 132. The card slit of the card socket 135 is open on one side of the housing 120.

A lens through hole 123 through which the lens 131 of the imaging module 130 is exposed to the front is formed in the front side of the housing 120. Vent holes 124 through which air may pass are formed at various locations including the front side of the housing 120 in order to dissipate heat that is generated by the circuit unit 132 when the imaging module 130 operates. Furthermore, an LED 125, that is, an indicator for indicating that the imaging module 130 is under operation, is mounted on the housing 120. The LED 125 is connected to the circuit unit 132 of the imaging module 130. The LED 125 may continue to keep turned on when the imaging module 130 operates, or may operate in such a way as to flicker at specific intervals. A power switch 126 for turning on or off power, an operation switch 127 for operating the imaging module 130, and a signal jack 128 for receiving USB memory or a power jack are provided on the bottom of the housing 120. A speaker hole 129 is formed through the bottom of the housing 120.

In the vehicle black box 100 according to the present embodiment, which is configured as described above, after the housing 120 has been fastened to the clamping part 110 by the hooking means, the fastening part 11 of the rear-view mirror support 10 is covered by the clamping part 110, and the screw 140 is fastened onto the rear side of the housing 120. Accordingly, the housing 120 and the support cover member 111 are detachably fastened to the fastening part 11 of the rear-view mirror support 10. A separation task may be simply performed only by releasing the fastened screw 140.

As illustrated in FIG. 5, the present embodiment may be applied to a case where the screw 140 is fastened between the housing 120 and the rear-view mirror 1 on the rear side of the housing 120.

FIG. 6 is a diagram illustrating a state in which a vehicle black box mountable on a rear-view mirror support according to a second embodiment of the present invention has been installed.

As in the first embodiment, the vehicle black box 200 according to the present embodiment is detachably mounted on a rear-view mirror support 10 by a fastening member while covering the rear-view mirror support 10. The vehicle black box 200 according to the present embodiment has the advantage of a wide range of use because the vehicle black box can be easily mounted on and separated from an existing rear-view mirror support as well as a newly installed rear-view mirror support.

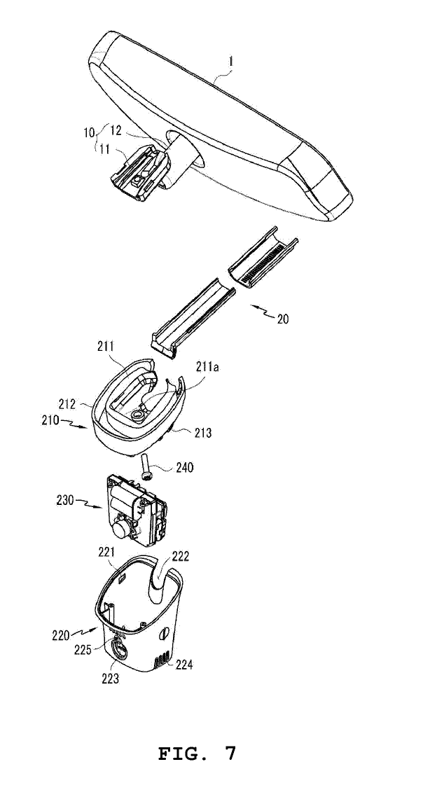

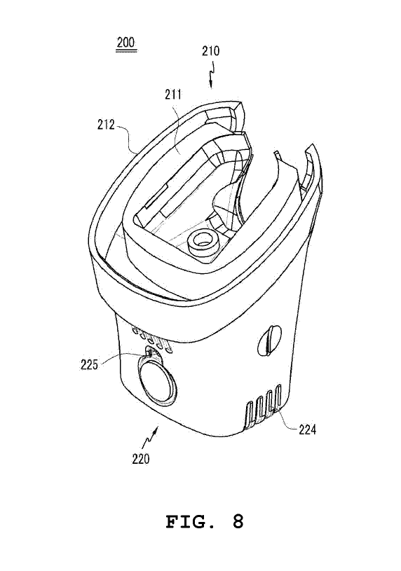

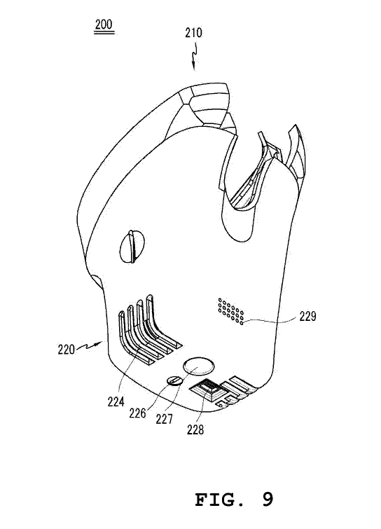

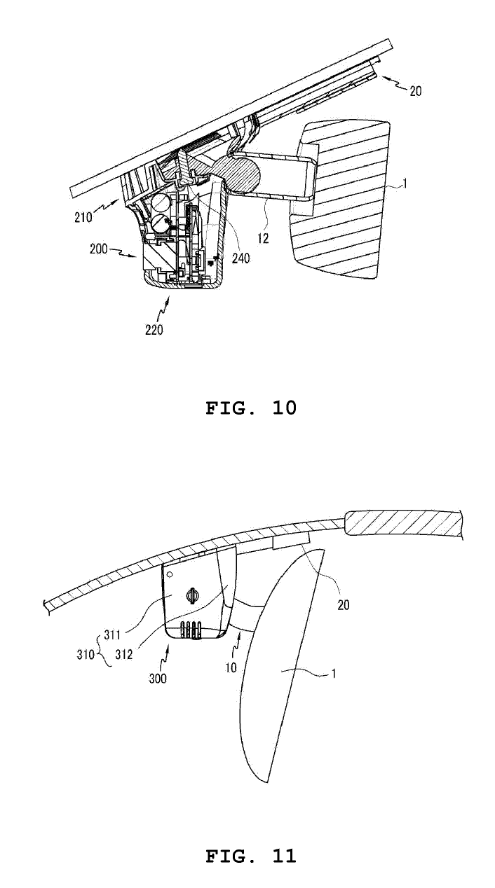

FIG. 7 is an exploded perspective view of the vehicle black box mountable on a rear-view mirror support according to the second embodiment of the present invention, FIG. 8 is a perspective view illustrating the assembled state of the vehicle black box illustrated in FIG. 7, FIG. 9 is a perspective view of FIG. 8 viewed from below, and FIG. 10 is a cross-sectional view illustrating a state in which the vehicle black box has been installed on the rear-view mirror support of FIG. 7.

The rear-view mirror support 10 includes a fastening part 11 fixedly attached to the windshield glass of the vehicle, and the rear-view mirror support part 12 rotatably combined with the fastening part 11 and to support the rear-view mirror 1. The fastening part 11 is fastened to the windshield glass by an adhesion means. The rear-view mirror support part 12 is configured such that the installation angle of the rear-view mirror 1 is freely controlled. The fastening part 11 may be fastened to other parts within the vehicle in addition to the windshield glass of a vehicle.

The vehicle black box 200 according to the present embodiment includes a clamping part 210 detachably combined with the rear-view mirror support 10 while covering the rear-view mirror support 10, a housing 220 detachably combined with the clamping part 210, and an imaging module 230 contained in the housing 220. In the present embodiment, the clamping part 210 and the housing 220 form a black box body. A signal lines and a power line connected to the imaging module 230 are inserted into and arranged in a line guide 20 that is installed on the ceiling of the vehicle and that is connected to the housing 220. The configuration of the line guide 20 is the same as that of the first embodiment.

A support cover member 211 is formed on the clamping part 210. The support cover member 211 has a recess so that it can cover the fastening part 11 of the rear-view mirror support 10. A glass contact member 212 that is spaced apart from the support cover member 211 and brought into contact with the windshield glass of the vehicle is formed outside the support cover member 211. A groove whose bottom is closed and whose top is open is formed between the support cover member 211 and the glass contact member 212.

A hollow screw hole 211a through which a screw 240 passes is formed on the support cover member 211 so that the support cover member 211 can be fastened to the fastening part 11 of the rear-view mirror support 10 by the screw 240. The top of the screw hole 211a extends into the inside of the support cover member 211. The bottom of the screw hole 211a extends downward from the support cover member 211. The screw 240 is longitudinally and upwardly fastened.

The glass contact member 112 may be attached to the windshield glass of a vehicle by an adhesion means, or may be simply brought into contact with the windshield glass of the vehicle. The glass contact member 112 may be inclined in accordance with the inclined surface of the windshield glass.

A plurality of fastening protrusions 213 is formed along the edge of the bottom of the clamping part 210 so that the housing 220 can be detachably combined with the clamping part 210 by a hooking means.

The imaging module 230 is detachably contained in the housing 220. The housing 220 has a cavity therein. The open top of the housing 220 is detachably combined with the clamping part 210 by a hooking means. For this purpose, fastening depressions 221 into which the fastening protrusions 213 of the clamping part 210 are detachably inserted are formed on the inside of the upper end of the housing 220. A support part reception portion 222 into and through which the rear-view mirror support part 12 of the rear-view mirror support 10 is inserted and passes is formed through the upper end of the rear side of the housing 220. The housing 220 may be combined with the clamping part 210 by a screw means in addition to a hooking means.

As in the first embodiment, a lens through hole 223, vent holes 224, an LED 225, a power switch 226, an operation switch 227, a signal jack 228, and a speaker hole 229 are formed on the housing 220.

Since the configuration of the imaging module 230 is the same as that of the imaging module of the first embodiment, a description thereof is omitted.

As illustrated in FIG. 10, in the present embodiment, after the clamping part 210 has been fastened to the fastening part 11 of the rear-view mirror support 10 by the screw 240, the housing 220 is fastened to the clamping part 210. Accordingly, when the screw 240 is fastened on the rear side of the housing 220, a fastening method, such as that of the present embodiment, may be preferred if no fastening space is not ensured due to the rear-view mirror 1.

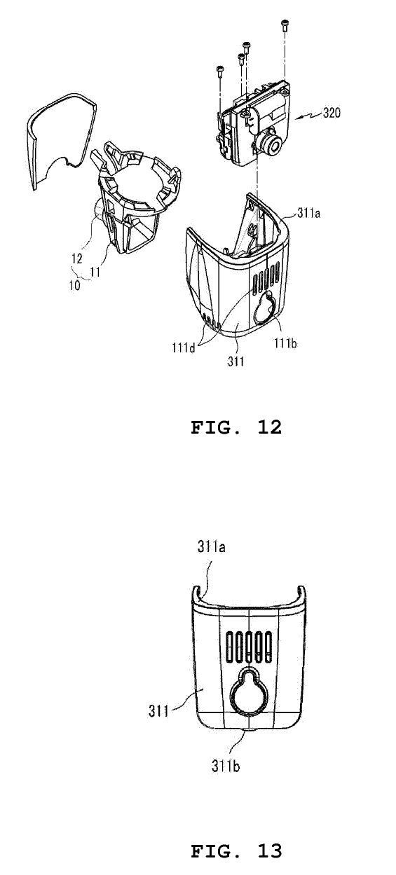

FIG. 11 is a diagram illustrating a state in which a vehicle black box mountable on a rear-view mirror support according to a third embodiment of the present invention has been installed within a vehicle, FIG. 12 is an exploded perspective view illustrating a state in which the vehicle black box has been separated from the rear-view mirror support in FIG. 11, FIG. 13 is a front view of a first housing illustrated in FIG. 12, and FIG. 14 is a side view of the first housing illustrated in FIG. 12.

As in the first and the second embodiments, the vehicle black box 300 according to the present embodiment has the advantage of a wide range of use because the vehicle black box is detachably mounted on the rear-view mirror support 10 while covering the rear-view mirror support 10 and also can be easily mounted on and separated from an existing rear-view mirror support in addition to a newly installed rear-view mirror support.

The rear-view mirror support 10 includes a fastening part 11 fixedly attached to the windshield glass of the vehicle, and the rear-view mirror support part 12 rotatably combined with the fastening part 11 and to support the rear-view mirror 1. The fastening part 11 is fastened to the windshield glass by an adhesion means. The rear-view mirror support part 12 is configured such that the installation angle of the rear-view mirror 1 is freely controlled. The fastening part 11 may be fastened to other parts within the vehicle in addition to the windshield glass of a vehicle.

The vehicle black box 300 according to the present embodiment includes a housing 310 fixedly installed on the rear-view mirror support 10, and an imaging module 320 contained in the housing 310 and to capture images in front of the vehicle. In the present embodiment, the housing 320 forms a black box body.

The housing 310 includes a first housing 311 to cover the front side of the fastening part 11 of the rear-view mirror support 10 when viewed from the front of the vehicle, and a second housing 312 detachably combined with the first housing 311 while covering the rear of the fastening part 11. That is, the first and second housings 311 and 312 are laterally separated from each other. When the fastening parts of the first housing 311 and the second housing 312 are brought in contact and combined with each other, the fastening part 11 of the rear-view mirror support 10 is fully covered by the first and second housings 311 and 312.

A glass contact member 311a that is brought into contact with the windshield glass within the vehicle is formed on the top of the first housing 311. The glass contact member 311a has a curved surface in accordance with the curved surface of the windshield glass, and thus the overall glass contact member 311a comes into contact with the windshield glass. Since the housing 310 comes into contact with the windshield glass as described above, an aesthetic appearance can be provided, and the stability of the housing 310 can be secured while the vehicle is running. That is, if the housing 310 remains separate from the windshield glass, there is a possibility that the fastened state of the housing 310 may be released because the housing 310 is shaken by vibrations that occur when the vehicle is running. If the housing 310 remains in contact with the windshield glass as in the present embodiment, however, there is no possibility that the housing 310 may be shaken while the vehicle is running because the housing 310 is supported by not only the windshield glass but also the rear-view mirror support 10. Accordingly, the fastened state of the housing 310 can be stably maintained. The glass contact member 311a may be integrated with the first housing 311, or may be separately formed and then combined with the first housing 311 by a separate fastening means.

Support reception holes 311b and 312a through which the rear-view mirror support part 12 of the rear-view mirror support 10 passes are formed in the lower fastening portions of the first and second housings 311 and 312. The support reception hole 311b formed in the first housing 311 and the support reception hole 312a formed in the second housing 312 are each configured to cover a half of the rear-view mirror support part 12 of the rear-view mirror support 10.

Since the configuration of the imaging module 320 is the same as those of the imaging modules of the first and the second embodiments, a description thereof is omitted. Furthermore, since the lens through hole, the vent holes, the LED, the power switch, the operation switch, the signal jack and the speaker hole formed on the housing in the first and the second embodiments are also formed on the housing 310 of the present embodiment in the same manner, descriptions thereof are omitted.

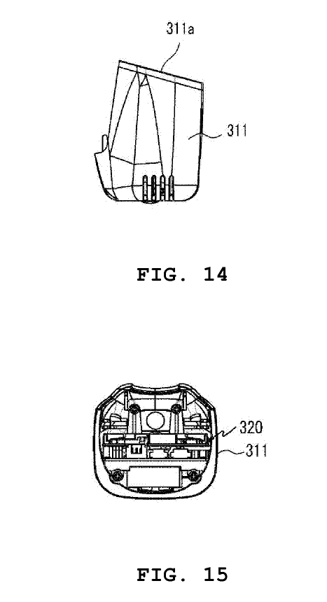

FIG. 15 is a plan view illustrating a state in which the imaging module has been mounted in the first housing in the vehicle black box mountable on a rear-view mirror support according to the third embodiment of the present invention.

As illustrated in FIG. 15, the imaging module 320 is contained in the first housing 311 so that the circuit unit can be longitudinally erected. The imaging module 320 is fastened to the first housing 311 by a screw. Although not illustrated, a slot may be formed in the first housing 311. In this case, the imaging module 320 may be inserted into the slot and then fastened therein by a screw.

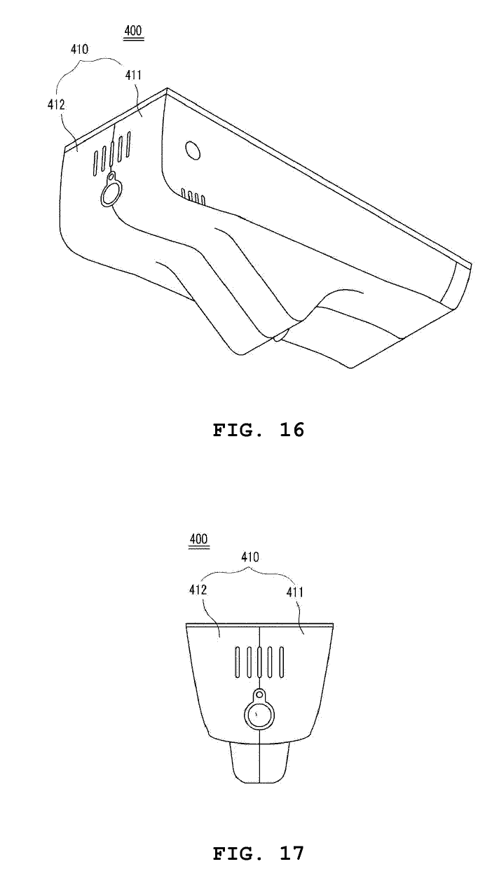

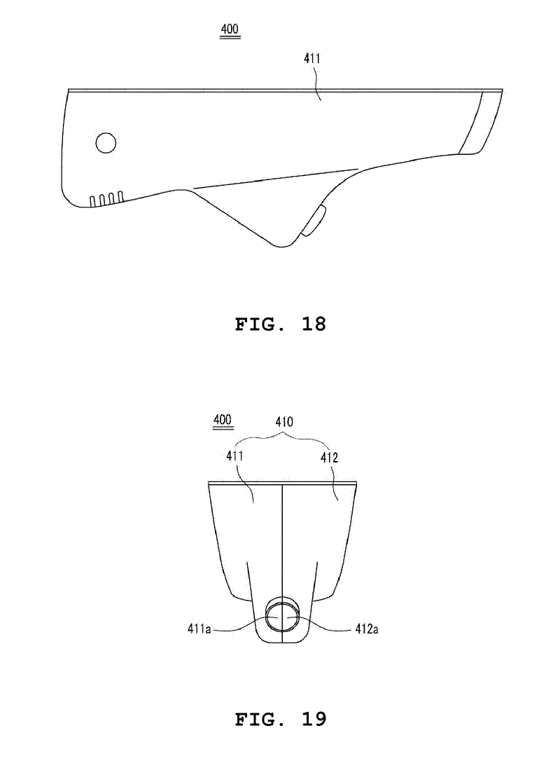

FIG. 16 is a perspective view of a vehicle black box mountable on a rear-view mirror support according to a fourth embodiment of the present invention, FIG. 17 is a front view of FIG. 16, FIG. 18 is a side view of FIG. 16, and FIG. 19 is a rear view of FIG. 16.

In the vehicle black box 400 according to the present embodiment, a housing 410 includes first and second housings 411 and 412 that are laterally separated from each other when viewed from the front of a vehicle. The first and second housings 411 and 412 are combined with each other while covering respective halves of the fastening part of the rear-view mirror support.

In the present embodiment, an imaging module (not illustrated) is contained in both the first and second housings 411 and 412. Support reception holes 411a and 412a through which the rear-view mirror support part of the rear-view mirror support passes are formed in the respective fastening portions of the first and second housings 411 and 412.

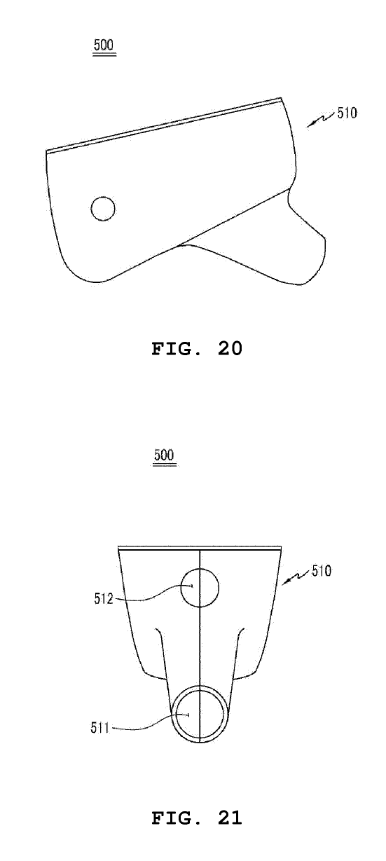

FIG. 20 is a side view of a vehicle black box mountable on a rear-view mirror support according to a fifth embodiment of the present invention, and FIG. 21 is a rear view of FIG. 20.

The housing 510 of the vehicle black box 500 according to the present embodiment has the same configuration as the housing of the fourth embodiment except a portion through which the rear-view mirror support passes and overall design. The rear-view mirror support may be equipped with a rear-view mirror support bar configured to support a rear-view mirror, and an electric wire connection bar connected to an electric wire. In this case, a support bar hole 511 through which the rear-view mirror support bar passes and a connection bar hole 512 through which the electric wire connection bar passes are formed in the housing 510.

As described above, the vehicle black box mountable on a rear-view mirror support may have the following advantages.

First, unless the black box body forming part of the vehicle black box is intentionally detached by a user, there is no possibility that it is detached even when it is used for a long time or in hot summer because the black box body is securely fastened to the rear-view mirror support.

Second, a windshield glass portion is not complicated and a wide visual field can be provided to a driver because the vehicle black box is integrated and combined with the rear-view mirror support. Furthermore, an additional advantage is achieved in that an aesthetic appearance is acquired.

Third, a wide range of use is achieved because the vehicle black box can be easily mounted on and separated from an existing rear-view mirror support in addition to a newly installed rear-view mirror support.

As described above, although the present invention has been described in detail based on the embodiments of the vehicle black box mountable on a rear-view mirror support, the present invention is not limited to the embodiments. Those skilled in the art can modify the present invention in various ways without departing from the scope of the claims. For example, although not described in the embodiments of the present invention, separate screws may be used to fasten the clamping part and the housing and to fasten the housings.

1. A vehicle black box mountable on a rear-view mirror support, the vehicle black box comprising:
an imaging module including a lens for capturing images and a circuit for driving the lens; and
a black box body containing the overall imaging module or part of the imaging module including the lens;
wherein the black box body is fastened to a fastening part forming a rear-view mirror support within a vehicle, while covering the fastening part.

2. The vehicle black box of claim 1, wherein the black box body comprises:
a clamping part detachably fastened to the fastening part using a fastening member while covering the fastening part; and
a housing detachably combined with the clamping part and containing all or part of the imaging module.

3. The vehicle black box of claim 2, wherein the clamping part comprises a support cover member having a recess so that it covers the fastening part, the support cover member having a screw hole through which a screw passes.

4. The vehicle black box of claim 3, wherein the screw sequentially passes through the black box body and the screw hole so that the black box body is fastened to the clamping part and hung onto a head part of the screw.

5. The vehicle black box of claim 3, wherein the clamping part and the housing are fastened to each other by a hooking means.

6. The vehicle black box of claim 1, wherein the black box body consists of two parts which may be divided longitudinally or laterally, the two parts being detachably combined with each other while covering the fastening part.

7. The vehicle black box of claim 1, wherein the black box body comprises:
a lens through hole through which the lens of the imaging module is exposed;
vent holes to dissipate heat generated on operating the imaging module;
an indicator to indicate that the imaging module is under operation;
a card socket into which a memory card is inserted;
a power switch to turn on or off power; and
an operation switch to control operation of the imaging module.

8. The vehicle black box of claim 2, wherein the black box body comprises:
a lens through hole through which the lens of the imaging module is exposed;
vent holes to dissipate heat generated on operating the imaging module;
an indicator to indicate that the imaging module is under operation;
a card socket into which a memory card is inserted;
a power switch to turn on or off power; and
an operation switch to control operation of the imaging module.

9. The vehicle black box of claim 3, wherein the black box body comprises:
a lens through hole through which the lens of the imaging module is exposed;
vent holes to dissipate heat generated on operating the imaging module;
an indicator to indicate that the imaging module is under operation;
a card socket into which a memory card is inserted;
a power switch to turn on or off power; and
an operation switch to control operation of the imaging module.

10. The vehicle black box of claim 4, wherein the black box body comprises:
a lens through hole through which the lens of the imaging module is exposed;
vent holes to dissipate heat generated on operating the imaging module;
an indicator to indicate that the imaging module is under operation;
a card socket into which a memory card is inserted;
a power switch to turn on or off power; and
an operation switch to control operation of the imaging module.

11. The vehicle black box of claim 5, wherein the black box body comprises:
a lens through hole through which the lens of the imaging module is exposed;
vent holes to dissipate heat generated on operating the imaging module;
an indicator to indicate that the imaging module is under operation;
a card socket into which a memory card is inserted;
a power switch to turn on or off power; and
an operation switch to control operation of the imaging module.

12. The vehicle black box of claim 6, wherein the black box body comprises:
a lens through hole through which the lens of the imaging module is exposed;
vent holes to dissipate heat generated on operating the imaging module;
an indicator to indicate that the imaging module is under operation;
a card socket into which a memory card is inserted;
a power switch to turn on or off power; and
an operation switch to control operation of the imaging module.
